(19) United States
(12) Patent Application Publication
(10) Pub. No.: US 2023/0076404 A1
(43) Pub. Date: Mar. 9, 2023

(54) TRAVELING STATE DETERMINATION APPARATUS, CUTTING-IN WARNING APPARATUS, METHOD, ANDCOMPUTER READABLE MEDIUM

(71) Applicant: NEC Corporation, Minato-ku,Tokyo (JP)

(72) Inventor: Nobuo FUWA, Tokyo (JP)

(73) Assignee: NEC Corporation, Minato-ku,Tokyo (JP)

(21) Appl. No.: 17/798,363

(22) PCT Filed: Feb. 9, 2021
(86) PCT No.: PCT/JP2021/004795

§ 371 Date: Aug. 9, 2022

(30) Foreign Application Priority Data
Feb. 19, 2020 (JP) 2020-026581

(51) Int. Cl. B60W 30/095; B60W 40/04; B60W 50/14

(52) U.S. Cl. CPC B60W 30/095; B60W 40/04; B60W 50/14; B60W 2554/80; B60W 2554/4042; B60W 2555/60; B60W 2554/4029

(57) ABSTRACT

A vehicle detection unit detects a plurality of vehicles traveling in an adjacent lane adjacent to a lane where the one vehicle is traveling, based on a sensor mounted on the vehicle. A speed information acquisition unit acquires speed information of a preceding vehicle traveling ahead of a target vehicle traveling right ahead of the one vehicle in the adjacent lane among the plurality of vehicles. A deceleration factor determination unit determines whether there is a deceleration factor in front of the preceding vehicle. A traveling state determination unit determines whether the target vehicle travels with the flow of traffic based on the speed information of the preceding vehicle and whether there is the deceleration factor.

### TECHNICAL FIELD

The present disclosure relates to a traveling state determination apparatus, a cutting-in warning apparatus, method, and computer readable medium.

### BACKGROUND ART

There is a known technique for predicting a dangerous event that could occur in the future which is not yet visible from the surrounding situation while a driver drives an automobile, and then alerting or controlling driving to avoid the danger before the event occurs. As one such technique, Patent Literature 1 discloses a cutting-in prediction apparatus for predicting a vehicle cutting in. The cutting-in prediction apparatus described in Patent Literature 1 acquires a traveling environment related to a vehicle on which the cutting-in prediction apparatus is mounted (such a vehicle will be hereinafter referred to as an own vehicle). The cutting-in prediction apparatus compares the acquired traveling environment with a past traveling environment acquired right before a peripheral vehicle cuts in. The cutting-in prediction apparatus calculates a probability at which cutting-in occurs based on a similarity between the present traveling environment and the traveling environment of the past vehicle cutting-in scene. When the probability at which cutting-in occurs is high, the cutting-in prediction apparatus predicts that a peripheral vehicle will cut in front of the own vehicle, and alerts the driver before it happens.

As another related art, Patent Literature 2 discloses a vehicle control apparatus for making overtaking predictions. The vehicle control apparatus according to Patent Literature 1 detects, as traveling information, the speeds and accelerations or decelerations of a plurality of adjacent vehicles traveling in an adjacent lane which is adjacent to a lane where the own vehicle travels. The vehicle control apparatus estimates a flow of traffic indicating traveling states of the plurality of adjacent vehicles based on the traveling information of the plurality of adjacent vehicles. The vehicle control apparatus estimates, as a vehicle not in the flow from among the plurality of adjacent vehicles, an adjacent vehicle whose estimated flow of traffic and the traveling information differ from those of other adjacent vehicles by more than or equal to a predetermined value. The vehicle control apparatus predicts that a vehicle (an overtaking vehicle) following the adjacent vehicle that is not traveling with the flow of traffic will overtake the adjacent vehicle. The vehicle control apparatus predicts a position where the overtaking vehicle overtakes the adjacent vehicle ahead of the overtaking vehicle and a timing at which the overtaking vehicle starts overtaking the adjacent vehicle. The vehicle control apparatus controls the own vehicle and avoids a collision when it is estimated that the own vehicle and the overtaking vehicle may collide.

### CITATION LIST

### Patent Literature

Patent Literature 1: Japanese Unexamined Patent Application Publication No. 2014-41434

Patent Literature 2: Japanese Unexamined Patent Application Publication No. 2016-030512

### SUMMARY OF INVENTION

### Technical Problem

In Patent Literature 1, when the traveling environment is close to the traveling environment of a past vehicle cutting-in scene, it is predicted that a peripheral vehicle will cut in the front of the own vehicle. In this case, even if the peripheral vehicle, which is a vehicle cutting in” does not intend to cut in at all, if the present traveling environment is highly similar to the traveling environment of the past vehicle cutting-in scene, it is predicted that the peripheral vehicle will cut in the front of the own vehicle, and an alert is issued. For example, even when the peripheral vehicle traveling ahead of the own vehicle in an adjacent lane is traveling to follow a vehicle ahead it, if the similarity between the present traveling environment and that of a past vehicle cutting-in scene is high, an alert is issued even if the peripheral vehicle has no intention to cut in at all. If the alert is issued and the peripheral vehicle does not actually cut in front of the own vehicle, the driver sees it as a false alarm. With a lot of false alarms, the driver is more likely to annoy the alarms and turn off the cut-in prediction feature.

For Patent Literature 2, a vehicle not travelling with the flow of traffic is estimated in accordance with a combination of speeds and accelerations of a plurality of vehicles traveling in adjacent vehicles, and the vehicle not travelling with the flow of traffic is estimated to be overtaken by a vehicle following that vehicle. However, in Patent Literature 2, the reason why each vehicle traveling in the adjacent lane accelerates or decelerates is not considered. Therefore, in a case where the traffic situation is complicated or the like, it may not be possible to correctly estimate whether or not the vehicle traveling in the adjacent lane is travelling with the flow of traffic.

In view of the above circumstances, an object of the present disclosure is to provide a traveling state determination apparatus, a cutting-in warning apparatus, method, and computer readable medium capable of more accurately estimating whether or not a vehicle traveling ahead of an own vehicle in an adjacent lane is traveling with a flow of traffic.

### Solution to Problem

In order to achieve the above object, the present disclosure provide a traveling state determination apparatus as a first example aspect. The traveling state determination apparatus includes: a vehicle detection unit configured to detect, based on a sensor mounted on a vehicle, a plurality of vehicles traveling in an adjacent lane adjacent to a lane where the vehicle is traveling; a speed information acquisition unit configured to acquire speed information of a preceding vehicle traveling ahead of a target vehicle traveling right ahead of the vehicle in the adjacent lane among the plurality of vehicles; a deceleration factor determination unit configured to determine whether or not there is a deceleration factor in front of the preceding vehicle; and a traveling state determination unit configured to determine whether or not the target vehicle travels with a flow of traffic based on the speed information of the preceding vehicle and whether or not there is the deceleration factor.

The present disclosure provide a traveling state determination method as a second example aspect. A traveling state determination method includes: detecting, based on a sensor mounted on a vehicle, a plurality of vehicles traveling in an adjacent lane adjacent to a lane where the vehicle is traveling; acquiring speed information of a preceding vehicle traveling ahead of a target vehicle traveling right ahead of the vehicle in the adjacent lane among the plurality of vehicles; determining whether or not there is a deceleration factor in front of the preceding vehicle; and determining whether or not the target vehicle travels with a flow of traffic based on the speed information of the preceding vehicle and whether or not there is the deceleration factor.

The present disclosure provide a computer readable medium as a third example aspect. The computer readable medium stores a program for causing a processor to execute processing of: detecting, based on a sensor mounted on a vehicle, a plurality of vehicles traveling in an adjacent lane adjacent to a lane where the vehicle is traveling; acquiring speed information of a preceding vehicle traveling ahead of a target vehicle traveling right ahead of the vehicle in the adjacent lane among the plurality of vehicles; determining whether or not there is a deceleration factor in front of the preceding vehicle; and determining whether or not the target vehicle travels with a flow of traffic based on the speed information of the preceding vehicle and whether or not there is the deceleration factor.

The present disclosure provide a cutting-in warning apparatus as a fourth example aspect. The cutting-in warning apparatus includes: a vehicle detection unit configured to detect, based on a sensor mounted on a vehicle, a plurality of vehicles traveling in an adjacent lane adjacent to a lane where the is traveling; a speed information acquisition unit configured to acquire speed information of a preceding vehicle traveling ahead of a target vehicle traveling right ahead of the vehicle in the adjacent lane among the plurality of vehicles; a deceleration factor determination unit configured to determine whether or not there is a deceleration factor in front of the preceding vehicle; a traveling state determination unit configured to determine whether or not the target vehicle travels with a flow of traffic based on the speed information of the preceding vehicle and whether or not there is the deceleration factor; a cutting-in prediction unit configured to predict that the target vehicle will cut in front of the vehicle based on statuses of the vehicle and the plurality of vehicles traveling in the adjacent lane; and an informing unit configured to warn a driver of the vehicle that cutting-in will occur when the cutting-in prediction unit predicts that the target vehicle will cut in and the traveling state determination unit does not determine that the target vehicle will travel with the flow of the traffic.

The present disclosure provide a cutting-in warning method as a fifth example aspect. The cutting-in warning method includes: detecting, based on a sensor mounted on a vehicle, a plurality of vehicles traveling in an adjacent lane adjacent to a lane where the vehicle is traveling; acquiring speed information of a preceding vehicle traveling ahead of a target vehicle traveling right ahead of the vehicle in the adjacent lane among the plurality of vehicles; determining whether or not there is a deceleration factor in front of the preceding vehicle; determining whether or not the target vehicle travels with a flow of traffic based on the speed information of the preceding vehicle and whether or not there is the deceleration factor; predicting that the target vehicle will cut in front of the vehicle based on statuses of the vehicle and the plurality of vehicles traveling in the adjacent lane; and warning a driver of the vehicle that cutting-in will occur when it is predicted that the target vehicle will cut in front of the vehicle and it is not determined that the target vehicle will travel with the flow of the traffic.

The present disclosure provide a computer readable medium as a sixth example aspect. The computer readable medium cutting-in warning method includes a program for causing a processor to execute processing of: detecting, based on a sensor mounted on a vehicle, a plurality of vehicles traveling in an adjacent lane adjacent to a lane where the vehicle is traveling; acquiring speed information of a preceding vehicle traveling ahead of a target vehicle traveling right ahead of the vehicle in the adjacent lane among the plurality of vehicles; determining whether or not there is a deceleration factor in front of the preceding vehicle; determining whether or not the target vehicle travels with a flow of traffic based on the speed information of the preceding vehicle and whether or not there is the deceleration factor; predicting that the target vehicle will cut in front of the vehicle based on statuses of the vehicle and the plurality of vehicles traveling in the adjacent lane; and warning a driver of the vehicle that cutting-in will occur when it is predicted that the target vehicle will cut in front of the vehicle and it is not determined that the target vehicle will travel with the flow of the traffic.

### Advantageous Effects of Invention

A traveling state determination apparatus, cutting-in warning apparatus, method, and computer readable medium capable of more accurately estimating whether or not a vehicle traveling ahead of an own vehicle in an adjacent lane is traveling with a flow of traffic.

### BRIEF DESCRIPTION OF DRAWINGS

FIG. 1 is a block diagram showing a traveling state determination apparatus according to a first example embodiment of the present disclosure;

FIG. 2 shows a positional relationship between an own vehicle and a plurality of vehicles traveling in an adjacent lane;

FIG. 3 is a flowchart showing an operation procedure of a traveling state determination apparatus;

FIG. 4 is a block diagram showing a cutting-in warning apparatus (a cutting-in occurrence prediction apparatus);

FIG. 5 is a flowchart showing an operation procedure in the cutting-in occurrence prediction apparatus; and

FIG. 6 is a block diagram showing a hardware configuration of an electronic control apparatus.

### EXAMPLE EMBODIMENT

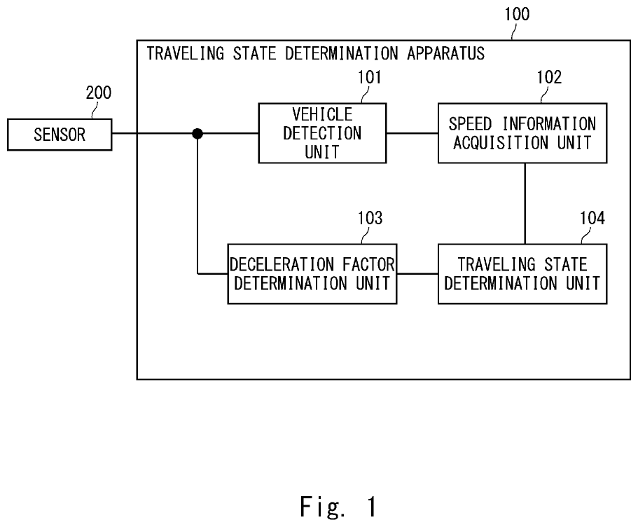

Hereinafter, example embodiments of the present disclosure will be described with reference to the drawings. FIG. 1 shows a traveling state determination apparatus according to a first example embodiment of the present disclosure. A traveling state determination apparatus 100 includes a vehicle detection unit 101, a speed information acquisition unit 102, a deceleration factor determination unit 103, and a traveling state determination unit 104. The traveling state determination apparatus 100 is mounted on a vehicle such as an automobile.

The traveling state determination apparatus 100 is connected to a sensor 200 mounted on the vehicle. The sensor 200 includes, for example, at least one of a camera, a radar, or a LiDAR (Light Detection and Ranging) for capturing an area in front of the vehicle. The traveling state determination apparatus 100 acquires sensor information from the sensor 200 via a network such as CAN (Controller Area Network).

The vehicle detection unit (vehicle detection means) 101 acquires sensor information from the sensor 200, and detects other vehicles present ahead of the own vehicle in a lane adjacent to a lane in which the own vehicle travels. For example, when the own vehicle is traveling in a second lane (a second traveling lane) from the left, the vehicle detection unit 101 detects a plurality of vehicles traveling in the same direction as that of the vehicle in the left lane (a first traveling lane). The traveling state determination apparatus 100 determines whether or not a vehicle traveling right ahead of the own vehicle in the adjacent lane among the plurality of detected vehicles is traveling with the flow of traffic.

The speed information acquisition unit (speed information acquisition means) 102 acquires the speed information of a vehicle traveling furthest ahead as seen from the own vehicle in the adjacent lane among the plurality of vehicles detected by the vehicle detection unit 101 (hereinafter such a vehicle will be referred to as a front vehicle). The speed information acquisition unit 102 acquires a traveling speed of the own vehicle. The speed information acquisition unit 102 acquires, for example, a speed and an acceleration of the front vehicle. The speed of the front vehicle can be calculated based on, for example, a relative speed between the own vehicle and the front vehicle and the traveling speed of the own vehicle.

Further, the speed information acquisition unit 102 acquires a maximum speed (maximum speed information) permitted for the road on which the own vehicle is traveling. The speed information acquisition unit 102 may, for example, recognize a traffic sign (a speed sign) from an image captured by a camera and acquire a speed limit (a regulatory speed) as the maximum allowable speed. Alternatively, the speed information acquisition unit 102 may acquire the maximum speed information from map information or VICS (Vehicle Information and Communication System) information. In general, the maximum speed on a road on which a vehicle is traveling is the speed limit or the legal speed limit.

The deceleration factor determination unit (deceleration factor determination means) 103 determines whether there is a factor for decelerating or stopping the vehicle ahead on the road where the own vehicle is traveling. The deceleration factor determination unit 103 acquires, for example, a lighting state of a traffic light present in front of the traveling direction. The deceleration factor determination unit 103 recognizes the traffic light from, for example, an image captured by a camera, and acquires the lighting state of the traffic light. The deceleration factor determination unit 103 may perform road-to-vehicle communication with the traffic light to obtain the lighting state. The deceleration factor determination unit 103 determines that a deceleration factor exists when the lighting state of the traffic light is red or yellow. The deceleration factor determination unit 103 determines that there is no deceleration factor when the lighting state of the traffic light is blue.

The traveling state determination unit (traveling state determination means) 104 determines whether or not a vehicle (a target vehicle to be determined) traveling right ahead of the own vehicle in the adjacent lane is traveling along the flow of traffic based on the speed information of the front vehicle acquired by the speed information acquisition unit 102 and a result of the determination made by the deceleration factor determination unit 103. The traveling state determination unit 104 determines whether or not the target vehicle is traveling along the flow of traffic based on the speed or acceleration of the front vehicle traveling in the adjacent lane and the lighting state of the traffic light.

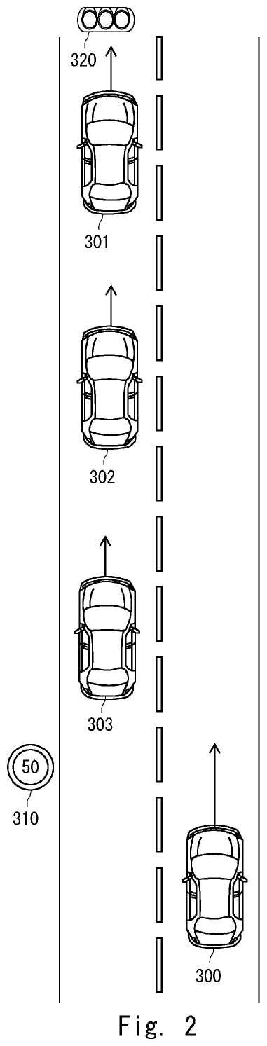

FIG. 2 shows a positional relationship between the own vehicle and a plurality of vehicles traveling in the adjacent lane. In FIG. 2, a vehicle (an own vehicle) 300 is traveling in a second traveling lane. It is assumed that the vehicle detection unit 101 detects three vehicles 301 to 303 traveling on a first traveling lane. The vehicle 303 is a target vehicle and travels right ahead of the own vehicle 300 in the first traveling lane. The vehicle 302 is a vehicle traveling one vehicle ahead of the target vehicle 303, and the vehicle 301 is a vehicle traveling two vehicles ahead of the target vehicle 303.

The speed information acquisition unit 102 acquires a speed and an acceleration of the vehicle 301 which is the front vehicle. The speed information acquisition unit 102 acquires the speed limit from a traffic sign 310 installed on the side of the road. In the example of FIG. 2, the speed information acquisition unit 102 acquires the speed limit of 50 km/h from the traffic sign 310. The deceleration factor determination unit 103 acquires the lighting state of a traffic light 320 installed further ahead of the front vehicle 301.

The vehicle from which the speed information acquisition unit 102 acquires the speed information may be a vehicle ahead of the vehicle (the target vehicle 303 in FIG. 2) traveling right ahead of the own vehicle in the adjacent lane, and is not necessarily limited to the front vehicle 301. For example, when a total of five vehicles are detected in the adjacent lane, the speed information acquisition unit 102 may acquire the speed information of the second, third, or fourth vehicle from the front among the four vehicles other than the target vehicle.

If the lighting state of the traffic light 320 indicates a stop, it is considered that the front vehicle 301 decelerates to stop before the traffic light 320. It is considered that the vehicle 302 decelerates following the deceleration of the front vehicle 301, and the target vehicle 303 also decelerates following the deceleration of the vehicle 302 ahead of it. In this case, it is considered that the target vehicle 303 travels following the vehicle ahead of it with the flow of traffic. Therefore, it can be said that a driver of the target vehicle 303 does not intend to change the lane to the second traveling lane and cut in front of the own vehicle 300.

On the other hand, when the lighting state of the traffic light 320 indicates that vehicles can proceed, it is not necessary to reduce the speed of the front vehicle 301 before the traffic light 320. In such a case, if the speed of the front vehicle 301 is about the speed limit, the target vehicle 303 is considered to travel following the vehicle ahead of it. In this case, it can be said that the driver of the target vehicle 303 does not intend to change the lane to the second traveling lane and cut in front of the own vehicle 300. On the other hand, if the speed of the front vehicle 301 is slower than the speed limit, the target vehicle 303 may change the lane to the second traveling lane in order to overtake the vehicles 301 and 302 without following the vehicle ahead of it.

Further, when the lighting state of the traffic light 320 indicates that vehicles can proceed, and the front vehicle 301 is accelerating from a low speed state, the target vehicle 303 is considered to travel following the vehicle ahead of it. In this case, it can be said that the driver of the target vehicle 303 does not intend to change the lane to the second traveling lane and cut in front of the own vehicle 300. On the other hand, if the front vehicle 301 is not accelerating from a low speed, the target vehicle 303 may not follow the vehicle ahead of it and may change the lane to the second traveling lane in order to overtake the vehicles 301 and 302.

In this example embodiment, the traveling state determination unit 104 determines whether or not the lighting state of the traffic light indicates a stop state or a proceeding allowed state. When the lighting state of the traffic light 320 indicates a stop, the traveling state determination unit 104 determines whether or not the front vehicle 301 is decelerating. The traveling state determination unit 104 determines that the target vehicle 303 travels with the flow of traffic when the front vehicle decelerates, that is, when the acceleration is negative.

The traveling state determination unit 104 determines whether or not the speed of the front vehicle 301 is greater than or equal to a predetermined speed when the lighting state of the traffic light 320 indicates that vehicles can proceed. For example, the predetermined speed is set to “speed limit−α”, where α is a margin for speed determination. When the speed of the front vehicle is greater than or equal to the “speed limit−α”, the traveling state determination unit 104 determines that the target vehicle 303 is traveling with the flow of traffic. When the speed of the front vehicle 301 is lower than the “speed limit−α”, the traveling state determination unit 104 determines whether or not the front vehicle 301 is accelerating. The traveling state determination unit 104 determines that the target vehicle 303 travels with the flow of traffic when the front vehicle is accelerating.

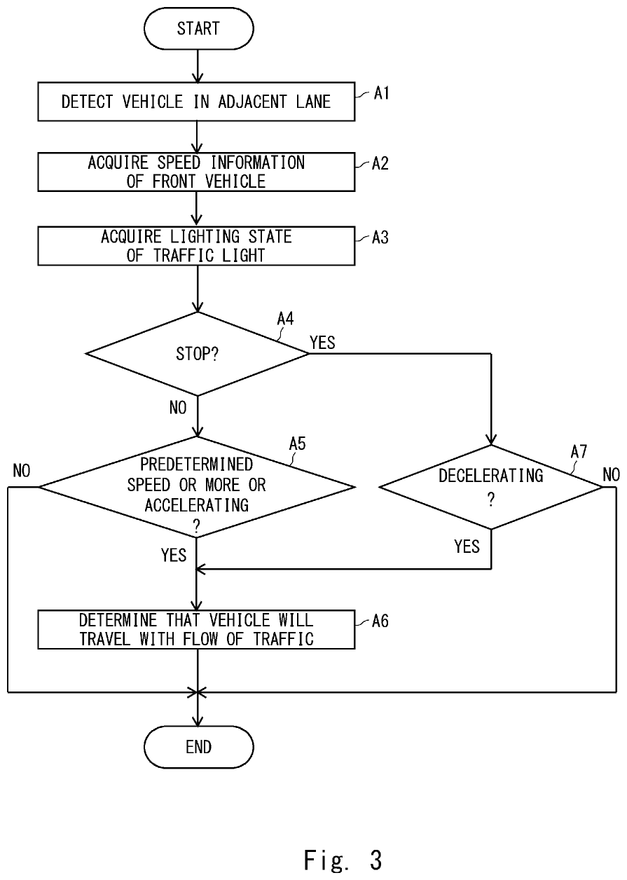

Next, an operation procedure (traveling state determination method) of the traveling state determination apparatus 100 will be described. FIG. 3 shows the operation procedure of the traveling state determining apparatus 100. The vehicle detection unit 101 acquires the sensor information from the sensor 200 and detects a vehicle traveling in the adjacent lane (Step A1). The speed information acquisition unit 102 acquires the speed information of the front vehicle among the detected vehicles (Step A2). In Step A2, the speed information acquisition unit 102 acquires, for example, the speed and the acceleration of the front vehicle.

The deceleration factor determination unit 103 acquires the lighting state of the traffic light (Step A3). The deceleration factor determination unit 103 obtains the lighting state of the traffic light installed in front of the front vehicle from an image captured by, for example, a camera for capturing the area in front of the vehicle. The deceleration factor determination unit 103 determines whether or not the lighting state of the traffic light indicates a stop (Step A4). When the lighting state of the traffic light indicates a stop, the deceleration factor determination unit 103 notifies the traveling state determination unit 104 of the lighting state. The deceleration factor determination unit 103 notifies the traveling state determination unit 104 of the lighting state when the lighting state of the traffic light does not indicate a stop, that is, when it indicates that vehicles can proceed.

When the lighting state of the traffic light indicates that vehicles can proceed, the traveling state determination unit 104 determines whether the speed of the front vehicle is greater than or equal to a predetermined speed or whether the vehicle is accelerating (Step A5). When the speed of the front vehicle is greater than or equal to the predetermined speed or is accelerating, the traveling state determination unit 104 determines that the target vehicle traveling right ahead of the own vehicle in the adjacent lane is traveling with the flow of traffic (Step A6). When the traveling state determination unit 104 determines that the target vehicle is traveling with the flow of traffic, it outputs the determination to a subsequent processing unit (not shown). When the speed of the front vehicle is lower than the predetermined speed and the vehicle is not accelerating, the traveling state determination unit 104 determines that it is unknown whether or not the target vehicle is traveling with the flow of traffic. In this case, it is not necessary for the traveling state determination unit 104 to specifically output a signal to a subsequent processing unit.

When the lighting state of the traffic light indicates a stop, the traveling state determination unit 104 determines whether or not the front vehicle is decelerating (Step A7). When the front vehicle is decelerating, the traveling state determination unit 104 proceeds to Step A6 and determines that the target vehicle traveling right ahead of the own vehicle in the adjacent lane is traveling with the flow of traffic. When the front vehicle is not decelerating, the traveling state determination unit 104 determines that it is unknown whether the target vehicle is traveling with the flow of traffic.

In this example embodiment, the traveling state determination unit 104 determines whether or not the target vehicle traveling ahead of the own vehicle in the separate lane is traveling with the flow of traffic based on the lighting state of the traffic light and the speed information of the front vehicle in the adjacent lane. For example, even when the front vehicle is decelerating, the traveling state determination unit 104 determines that the target vehicle is traveling with the flow of traffic if the lighting state of the traffic light indicates a stop. In this example embodiment, by combining the lighting state of the traffic light, which is a deceleration factor, with the speed information, it is possible to correctly estimate whether or not a vehicle traveling in the adjacent lane travels with the flow of traffic, even when a traffic situation of general roads or the like is complicated.

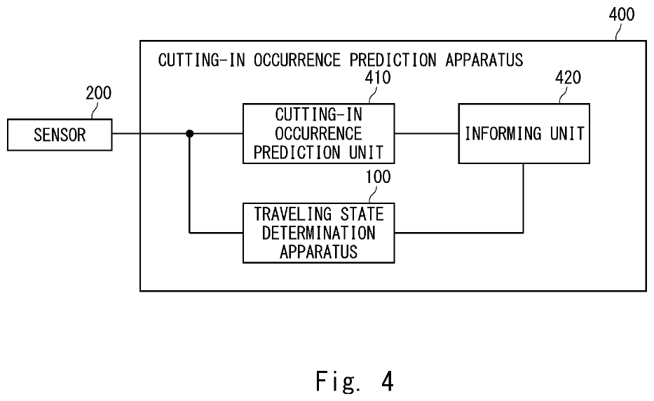

Next, a cutting-in warning apparatus according to a second example embodiment of the present disclosure will be described. FIG. 4 shows a cutting-in warning apparatus (a cutting-in occurrence prediction apparatus). The cutting-in occurrence prediction apparatus 400 includes a traveling state determination apparatus 100, a cutting-in occurrence prediction unit 410, and an informing unit 420. In the cutting-in occurrence prediction apparatus 400, the traveling state determination apparatus 100 and the cutting-in occurrence prediction unit 410 are not necessarily separated. Some of the functions of the traveling state determination apparatus 100 and some of the functions of the cutting-in occurrence prediction unit 410 may be the same. The traveling state determination apparatus 100 and the cutting-in occurrence prediction unit 410 may be physically separated from each other or may be the same.

The cutting-in occurrence prediction unit (a cutting-in prediction means) 410 predicts that a vehicle traveling ahead of the own vehicle in the adjacent lane will change the lane and cut in front of the own vehicle. The cutting-in occurrence prediction unit 410 uses, for example, the sensor 200 to acquire the status of the surroundings of the own vehicle. The cutting-in occurrence prediction unit 410 detects, for example, a plurality of vehicles traveling in the adjacent lane, and acquires the relative position and speed of each vehicle and the speed of the own vehicle. The cutting-in occurrence prediction unit 410, for example, compares the present surrounding status with a dangerous scene prediction model to predict a possibility of a cutting-in occurrence. The dangerous scene prediction model is created by learning, for example, the relative position of each vehicle, the relative speed, the speed of the own vehicle, and the like in a case where cutting-in has occurred in the past.

The cutting-in occurrence prediction unit 410 calculates a probability (a cutting-in occurrence probability) that a target vehicle traveling ahead of the own vehicle in the adjacent lane will cut in the front of the own vehicle by using the dangerous scene prediction model. The cutting-in occurrence prediction unit 410 predicts that cutting-in will occur when the cutting-in occurrence probability is greater than or equal to a threshold value. When the cutting-in occurrence prediction unit 410 predicts that cutting-in will occur, it outputs that prediction to the informing unit 420. Note that the method for predicting whether or not the target vehicle will cut in may be any method, and not limited to the above method. The cutting-in occurrence prediction unit 410 may predict that the target vehicle will cut in by using other known methods.

As described in the first example embodiment, the traveling state determination apparatus 100 determines whether or not a target vehicle traveling right ahead of the own vehicle in the adjacent lane travels with the flow of traffic. This target vehicle is the same as the target vehicle in the cutting-in occurrence prediction unit 410. When the traveling state determination apparatus 100 determines that the target vehicle travels with the flow of traffic, it outputs the determination to the informing unit 420.

The informing unit (informing means) 420 alerts the driver of the own vehicle when it receives a notification from the cutting-in occurrence prediction unit 410 that cutting-in will occur and when it has not received a notification from the traveling state determination apparatus 100 that the target vehicle is traveling with the flow of traffic. The informing unit 420 alerts the driver by, for example, displaying a sign or a sound before cutting-in actually occurs. Even when the notification that cutting-in will occur is received from the cutting-in occurrence prediction unit 410, the informing unit 420 does not alert the driver if the notification that the target vehicle is traveling with the flow of traffic is received from the traveling state determination apparatus 100.

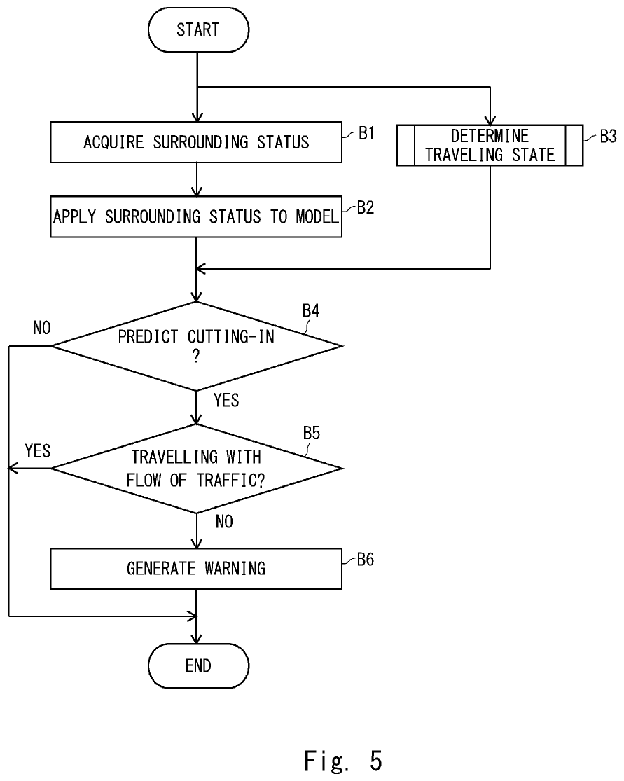

FIG. 5 shows an operation procedure (a cutting-in warning method) in the cutting-in occurrence prediction apparatus 400. The cutting-in occurrence prediction unit 410 acquires the sensor information from the sensor 200, and acquires the surrounding status of the own vehicle (Step B1). The cutting-in occurrence prediction unit 410 applies the acquired status to the prediction model (Step B2). In Step B2, for example, the cutting-in occurrence prediction unit 410 calculates the probability that a target vehicle traveling right ahead of the own vehicle in the adjacent lane will cut in the front of the own vehicle.

The traveling state determination apparatus 100 determines the traveling state of the target vehicle traveling right ahead of the own vehicle in the adjacent lane (Step B3). The traveling state determination apparatus 100 determines whether or not the target vehicle is traveling with the flow of traffic according to an operation procedure shown in FIG. 3. Prediction of the occurrence of the cutting-in in Steps B1 and B2 and determination of the traveling state in Step B3 may be performed in parallel.

The informing unit 420 determines whether or not the cutting-in occurrence prediction unit 410 has predicted that the target vehicle will cut in the front of the own vehicle (Step B4). When it is predicted that the target vehicle will cut in front of the own vehicle, the informing unit 420 determines whether or not it is determined that the target vehicle will travel with the flow of traffic (Step B5). The informing unit 420 generates a warning when it is predicted that the target vehicle will cut in front of the own vehicle and it is not determined that the target vehicle will travel with the flow of traffic (Step B6). The informing unit 420 does not generate a warning when it is not predicted that the target vehicle will cut in front of the own vehicle, or when it is determined that the target vehicle will travel with the flow of traffic.

In this example embodiment, even when the occurrence of cutting-in is predicted, if it is determined that the target vehicle is traveling with the flow of traffic, the driver is not alerted. In this example embodiment, even when the present status is similar to the vehicle cutting-in scene in the past, if the target vehicle does not intend to cut in, an alert is not generated. By doing so, it is possible to prevent the generation of the cutting-in warning when the cutting-in does not actually occur, thereby eliminating bothersome of the driver. As a result, the possibility that the cutting-in prediction function is turned off can be reduced.

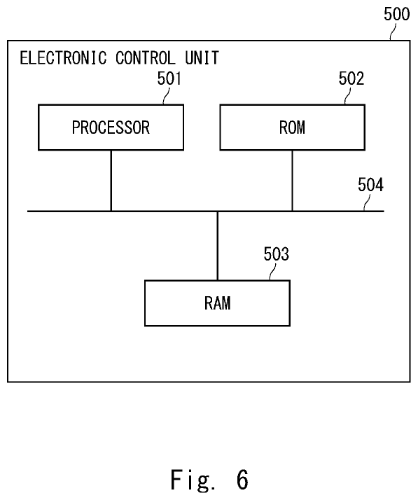

In the present disclosure, the traveling state determination apparatus 100 and the cutting-in generation prediction apparatus 400 may be configured as electronic control units. FIG. 6 shows a hardware configuration of an electronic control apparatus that can be used for the traveling state determination apparatus 100 and the cutting-in generation prediction apparatus 400. An electronic control unit 500 includes a processor 501, a ROM (read only memory) 502, and a RAM (random access memory) 503. In the electronic control unit 500, the processor 501, the ROM (read only memory) 502, and the RAM (random access memory) 503 are connected to each other via a bus 504. The electronic control unit 500 may include other circuitry, such as peripheral circuitry, communication circuitry, and interface circuitry, which are not shown.

The ROM 502 is a non-volatile storage device. The ROM 502 is a semiconductor memory device such as a flash memory having a relatively small capacity. The ROM 502 stores a program executed by the processor 501.

The above program can be stored and provided to the electronic control unit 500 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), optical disk medium such as CD (compact disc) and DVD (digital versatile disk), and semiconductor memories (such as mask ROM, PROM (programmable ROM), EPROM (erasable PROM), flash ROM, RAM, etc.). The program may be provided to the electronic control unit using any type of transitory computer readable media. Examples of transitory computer readable media include electric signals, optical signals, and electromagnetic waves. Transitory computer readable media can provide the program to the electronic control unit via a wired communication line (e.g. electric wires, and optical fibers) or a wireless communication line.

The RAM 503 is a volatile storage device. Various semiconductor memory devices such as a DRAM (Dynamic Random Access Memory) or an SRAM (Static Random Access Memory) are used as the RAM 503. The RAM 540 may be used as an internal buffer for temporarily storing data and the like.

The processor 501 expands the program stored in the ROM 502 into the RAM 503 and executes it. The functions of each unit of the traveling state determination apparatus 100 or the cutting-in occurrence prediction apparatus 400 can be implemented by the CPU 501 executing the program.

In the above example embodiments, an example in which the deceleration factor determination unit 103 determines that there is a deceleration factor when a lighting state of a traffic light indicates a stop, but the present disclosure is not limited to this. For example, the deceleration factor determination unit 103 may recognize a pedestrian crossing where no traffic light is installed, and may detect whether or not there is a person crossing at the pedestrian crossing. The deceleration factor determination unit 103 may determine that there is a deceleration factor when there is a person crossing, in a manner similar to when the lighting state of the traffic light indicates a stop. The deceleration factor determination unit 103 may determine that there is no deceleration factor when there is no person crossing, as in the case where the effective state of the traffic light indicates that vehicles can proceed.

Although the example embodiments of the present disclosure have been described above in detail, the present disclosure is not limited to the above-described example embodiments, and changes or modifications to the above-described example embodiments are also included in the present disclosure to the extent that they do not depart from the spirit of the present disclosure.

The whole or part of the example embodiments disclosed above can be described as, but not limited to, the following supplementary notes.

### Supplementary Note 1

A traveling state determination apparatus comprising:

a vehicle detection unit configured to detect, based on a sensor mounted on a vehicle, a plurality of vehicles traveling in an adjacent lane adjacent to a lane where the vehicle is traveling;

a speed information acquisition unit configured to acquire speed information of a preceding vehicle traveling ahead of a target vehicle traveling right ahead of the vehicle in the adjacent lane among the plurality of vehicles;

a deceleration factor determination unit configured to determine whether or not there is a deceleration factor in front of the preceding vehicle; and

a traveling state determination unit configured to determine whether or not the target vehicle travels with a flow of traffic based on the speed information of the preceding vehicle and whether or not there is the deceleration factor.

### Supplementary Note 2

The traveling state determination apparatus according to Supplementary note 1, wherein

the speed information acquisition unit acquires the speed information of a front vehicle among the plurality of vehicles.

### Supplementary Note 3

The traveling state determination apparatus according to Supplementary note 1 or 2, wherein

the speed information acquisition unit acquires a speed and an acceleration of the preceding vehicle as the speed information.

### Supplementary Note 4

The traveling state determination apparatus according to any one of Supplementary notes 1 to 3, wherein

the deceleration factor determination unit determines that there is a deceleration factor when a traffic light is present in front of the preceding vehicle and a lighting state of the traffic light indicates a stop.

### Supplementary Note 5

The traveling state determination apparatus according to any one of Supplementary notes 1 to 4, wherein

the deceleration factor determination unit determines that a deceleration factor is present when there is a pedestrian crossing in front of the preceding vehicle and a person crosses the pedestrian crossing.

### Supplementary Note 6

The traveling state determination apparatus according to any one of Supplementary notes 1 to 5, wherein

the traveling state determination unit determines that the target vehicle travels with the flow of traffic when the deceleration factor determination unit determines that there is a deceleration factor and when the preceding vehicle is decelerating.

### Supplementary Note 7

The traveling state determination apparatus according to any one of Supplementary notes 1 to 6, wherein

the traveling state determination unit determines that the target vehicle travels with the flow of traffic when the deceleration factor determination unit determines that there is no deceleration factor and when the speed of the preceding vehicle is a predetermined speed or more.

### Supplementary Note 8

The traveling state determination apparatus according to Supplementary note 7, wherein

the predetermined speed is set to a speed lower by a predetermined margin than a speed limit or a legal speed limit of a road on which the vehicles travel.

### Supplementary Note 9

The traveling state determination apparatus according to any one of Supplementary notes 1 to 8, wherein

the traveling state determination unit determines that the target vehicle travels with the flow of traffic when the deceleration factor determination unit determines that there is no deceleration factor and when the preceding vehicle is accelerating.

### Supplementary Note 10

A cutting-in warning apparatus comprising:

a vehicle detection unit configured to detect, based on a sensor mounted on a vehicle, a plurality of vehicles traveling in an adjacent lane adjacent to a lane where the is traveling;

a speed information acquisition unit configured to acquire speed information of a preceding vehicle traveling ahead of a target vehicle traveling right ahead of the vehicle in the adjacent lane among the plurality of vehicles;

a deceleration factor determination unit configured to determine whether or not there is a deceleration factor in front of the preceding vehicle;

a traveling state determination unit configured to determine whether or not the target vehicle travels with a flow of traffic based on the speed information of the preceding vehicle and whether or not there is the deceleration factor;

a cutting-in prediction unit configured to predict that the target vehicle will cut in front of the vehicle based on statuses of the vehicle and the plurality of vehicles traveling in the adjacent lane; and

an informing unit configured to warn a driver of the vehicle that cutting-in will occur when the cutting-in prediction unit predicts that the target vehicle will cut in and the traveling state determination unit does not determine that the target vehicle will travel with the flow of the traffic.

### Supplementary Note 11

The cutting-in warning apparatus according to Supplementary note 10, wherein

the informing unit does not warn the driver that cutting-in will occur when the cutting-in prediction unit predicts that the target vehicle will cut in and the traveling state determination unit determines that the target vehicle will travel with the flow of the traffic.

### Supplementary Note 12

The cutting-in warning apparatus according to Supplementary note 10 or 11, wherein

the cutting-in prediction unit acquires a status of the vehicle and the plurality of vehicles traveling in the adjacent lane, and compares the acquired status with a dangerous scene prediction model to predict a possibility of an occurrence of cutting-in.

### Supplementary Note 13

A traveling state determination method comprising:

detecting, based on a sensor mounted on a vehicle, a plurality of vehicles traveling in an adjacent lane adjacent to a lane where the vehicle is traveling;

acquiring speed information of a preceding vehicle traveling ahead of a target vehicle traveling right ahead of the vehicle in the adjacent lane among the plurality of vehicles;

determining whether or not there is a deceleration factor in front of the preceding vehicle; and

determining whether or not the target vehicle travels with a flow of traffic based on the speed information of the preceding vehicle and whether or not there is the deceleration factor.

### Supplementary Note 14

A cutting-in warning method comprising:

detecting, based on a sensor mounted on a vehicle, a plurality of vehicles traveling in an adjacent lane adjacent to a lane where the vehicle is traveling;

acquiring speed information of a preceding vehicle traveling ahead of a target vehicle traveling right ahead of the vehicle in the adjacent lane among the plurality of vehicles;

determining whether or not there is a deceleration factor in front of the preceding vehicle;

determining whether or not the target vehicle travels with a flow of traffic based on the speed information of the preceding vehicle and whether or not there is the deceleration factor;

predicting that the target vehicle will cut in front of the vehicle based on statuses of the vehicle and the plurality of vehicles traveling in the adjacent lane; and

warning a driver of the vehicle that cutting-in will occur when it is predicted that the target vehicle will cut in front of the vehicle and it is not determined that the target vehicle will travel with the flow of the traffic.

### Supplementary Note 15

A program for causing a processor to execute processing of:

detecting, based on a sensor mounted on a vehicle, a plurality of vehicles traveling in an adjacent lane adjacent to a lane where the vehicle is traveling;

acquiring speed information of a preceding vehicle traveling ahead of a target vehicle traveling right ahead of the vehicle in the adjacent lane among the plurality of vehicles;

determining whether or not there is a deceleration factor in front of the preceding vehicle; and

determining whether or not the target vehicle travels with a flow of traffic based on the speed information of the preceding vehicle and whether or not there is the deceleration factor.

### Supplementary Note 16

A program for causing a processor to execute processing of:

detecting, based on a sensor mounted on a vehicle, a plurality of vehicles traveling in an adjacent lane adjacent to a lane where the vehicle is traveling;

acquiring speed information of a preceding vehicle traveling ahead of a target vehicle traveling right ahead of the vehicle in the adjacent lane among the plurality of vehicles;

determining whether or not there is a deceleration factor in front of the preceding vehicle;

determining whether or not the target vehicle travels with a flow of traffic based on the speed information of the preceding vehicle and whether or not there is the deceleration factor;

predicting that the target vehicle will cut in front of the vehicle based on statuses of the vehicle and the plurality of vehicles traveling in the adjacent lane; and

warning a driver of the vehicle that cutting-in will occur when it is predicted that the target vehicle will cut in front of the vehicle and it is not determined that the target vehicle will travel with the flow of the traffic.

This application claims priority on the basis of Japanese Patent Application No. 2020-026581, filed Feb. 19, 2020, the entire disclosure of which is incorporated herein by reference.

### REFERENCE SIGNS LIST

100 TRAVELING STATE DETERMINATION APPARATUS

101 VEHICLE DETECTION UNIT

102 SPEED INFORMATION ACQUISITION UNIT

103 DECELERATION FACTOR DETERMINATION UNIT

104 TRAVELING STATE DETERMINATION UNIT

200 SENSOR

300 OWN VEHICLE

301 TO 303 VEHICLE

310 TRAFFIC SIGN

320 TRAFFIC LIGHT

400 CUTTING-IN OCCURRENCE PREDICTION APPARATUS

410 CUTTING-IN OCCURRENCE PREDICTION UNIT

420 INFORMING UNIT

What is claimed is:

1. A traveling state determination apparatus comprising:
at least one memory storing instructions, and
at least one processor configured to execute the instructions to:
detect, based on a sensor mounted on a vehicle, a plurality of vehicles traveling in an adjacent lane, the adjacent lane being adjacent to a lane where the vehicle is traveling;
acquire speed information of a preceding vehicle traveling ahead of a target vehicle in the adjacent lane, the target vehicle traveling right ahead of the vehicle in the adjacent lane among the plurality of vehicles;
determine whether or not there is a deceleration factor in front of the preceding vehicle; and
determine whether or not the target vehicle travels with a flow of traffic based on the speed information of the preceding vehicle and whether or not there is the deceleration factor.

2. The traveling state determination apparatus according to claim 1, wherein
the at least one processor further configured to execute the instructions to:
acquire the speed information of a front vehicle among the plurality of vehicles.

3. The traveling state determination apparatus according to claim 1, wherein
the at least one processor further configured to execute the instructions to:
acquire a speed and an acceleration of the preceding vehicle as the speed information.

4. The traveling state determination apparatus according to claim 1, wherein
the at least one processor further configured to execute the instructions to:
determine that there is a deceleration factor in a case that a traffic light is present in front of the preceding vehicle and a lighting state of the traffic light indicates a stop.

5. The traveling state determination apparatus according to claim 1, wherein
the at least one processor further configured to execute the instructions to:
determine that a deceleration factor is present in a case that there is a pedestrian crossing in front of the preceding vehicle and a person crosses the pedestrian crossing.

6. The traveling state determination apparatus according to claim 1, wherein
the at least one processor further configured to execute the instructions to:
determine that the target vehicle travels with the flow of traffic in a case that it is determined that there is a deceleration factor and the preceding vehicle is decelerating.

7. The traveling state determination apparatus according to claim 1, wherein
the at least one processor further configured to execute the instructions to:
determine that the target vehicle travels with the flow of traffic in a case that it is determined that that there is no deceleration factor and the speed of the preceding vehicle is a predetermined speed or more.

8. The traveling state determination apparatus according to claim 7, wherein
the predetermined speed is set to a speed lower by a predetermined margin than a speed limit or a legal speed limit of a road on which the vehicles travel.

9. The traveling state determination apparatus according to claim 1, wherein
the at least one processor further configured to execute the instructions to:
determine that the target vehicle travels with the flow of traffic in a case that it is determined that there is no deceleration factor and the preceding vehicle is accelerating.

10. A cutting-in warning apparatus comprising:
at least one memory storing instructions, and
at least one processor configured to execute the instructions to:
detect, based on a sensor mounted on a vehicle, a plurality of vehicles traveling in an adjacent lane, the adjacent lane being adjacent to a lane where the is traveling;
to acquire speed information of a preceding vehicle traveling ahead of a target vehicle in the adjacent lane, the target vehicle traveling right ahead of the vehicle in the adjacent lane among the plurality of vehicles;
determine whether or not there is a deceleration factor in front of the preceding vehicle;
determine whether or not the target vehicle travels with a flow of traffic based on the speed information of the preceding vehicle and whether or not there is the deceleration factor;
predict that the target vehicle will cut in front of the vehicle based on statuses of the vehicle and the plurality of vehicles traveling in the adjacent lane; and
warn a driver of the vehicle that cutting-in will occur when predicts it is predicted that the target vehicle will cut in and it is determined that the target vehicle will travel with the flow of the traffic.

11. The cutting-in warning apparatus according to claim 10, wherein
the at least one processor further configured to execute the instructions to:
not warn the driver that cutting-in will occur a case that it is predicted that the target vehicle will cut in and determines it is determined that the target vehicle will travel with the flow of the traffic.

12. The cutting-in warning apparatus according to claim 10, wherein
the at least one processor further configured to execute the instructions to:
acquire a status of the vehicle and the plurality of vehicles traveling in the adjacent lane, and compare the acquired status with a dangerous scene prediction model to predict a possibility of an occurrence of cutting-in.

13. A traveling state determination method comprising:
detecting, based on a sensor mounted on a vehicle, a plurality of vehicles traveling in an adjacent lane, the adjacent lane being adjacent to a lane where the vehicle is traveling;
acquiring speed information of a preceding vehicle traveling ahead of a target vehicle in the adjacent lane, the target vehicle traveling right ahead of the vehicle in the adjacent lane among the plurality of vehicles;
determining whether or not there is a deceleration factor in front of the preceding vehicle; and
determining whether or not the target vehicle travels with a flow of traffic based on the speed information of the preceding vehicle and whether or not there is the deceleration factor.

14.-16. (canceled)
